(19) United States
(12) Patent Application Publication
(10) Pub. No.: US 2012/0109702 A1
(43) Pub. Date: May 3, 2012

(54) STANDARD KNOWLEDGE MANAGEMENT INFORMATION SYSTEM

(76) Inventor: Yiu Wai Leung, (US)

(21) Appl. No.: 12/938,912

(22) Filed: Nov. 3, 2010

(51) Int. Cl. G06Q 10/00

(52) U.S. Cl. 705/7.15; 705/30; 705/7.13

(57) ABSTRACT

Systems and methods are provided for associating business processes with knowledge management. In accordance with one implementation, a system is configured to perform a knowledge assessment to collect documents of the entire enterprise. The system is further configured to associate all of the required documents related to a business process of the enterprise. Further, the system provides editing the collected documents by an assigned owner of the documents, a new employee of the enterprise. In addition, the system is configured to perform a knowledge management audit by the executives of the enterprise.

### BACKGROUND

I. Technical Field

The present invention generally relates to the field of knowledge management. Specifically, and without limitation, the invention relates to applying workflow management with knowledge management.

II. Background Information

Nowadays, most organizations have well defined and documented their business processes by adopting the traditional process documentation regime. However, their current processed documents contained only basic business process information such as information about operational flow, working guideline and scope of owners' responsibilities. There are instances where external information such as government regulations, tacit Knowledge and external product and/or services standards are not incorporated in the traditional process documentation regime. The concerned system addresses these issues by incorporating knowledge management with workflow system plus GPS system so that authentication can be enhanced.

Standard KM Implementation Methodology” (SKMIM) is crucial for every KM implementation. Therefore, a world-recognized “KM Implementation Practice” is needed to ensure the quality of every KM implementation. Well defined KM implementation phases are highly needed because they will facilitate the application of standardized processes such as the ones that are introduced in this invention—“Standard KM Consultation Tools”, “Standard KM Implementation Methodologies” and KPI on each implementation phase.

The KM implementation process is divided into 3 phases:

1^{st} Phase “Pre-KM Implementation”—(KM Assessment Process, Culture Change Education).

2^{nd} Phase “Building KM Foundation”—(Analyzing, Consolidating and Visualizing Knowledge Assets by employing the Knowledge Map).

3^{rd} Phase “Post-KM Implementation”—(Perpetual Evergreen Process).

To implement the above concepts, two small scale projects were conducted in a large razor product manufacturing enterprise. During the 1^{st} phase of the Projects, key executives of the enterprise were requested to complete one or more “KM Assessment Template”. This template enabled us to determine the working knowledge level of the key employees. Then, a “Knowledge Checklist” was created based on the KM Assessment Results. These completed Checklist became part of the key reference material for the “KM Audit process” in the 3^{rd} Phase.

During the 2^{nd} phase of the Projects, an Organizational “Knowledge Map” was constructed. With this “Map”, an analysis on the Knowledge Model was conducted to identify the KM requirements such as Knowledge Security, Knowledge Residual etc.

The details of the 3^{rd} phase, which is KM Audit Process are further elaborated in the invention.

The findings of the two “Proof of Concept” Projects illustrated that the “SKMIM” KM deployment approach is extremely practical and systematic for on “Business Area”. However, advancing the “SKMIM” into a “Universal KM Practice” still requires a lot of thoughts and effort. Further research and development are needed to perfect the “Universal KM Implementation” Practice.

Moreover, most companies are fast becoming Knowledge Centric Organizations. Full application of Knowledge Management (KM) is the key for sustaining their future growth and success in their respective market segment. However, most companies do not know “where” and “how” to commence their KM initiatives; ironically many of them do not know how to effectively use KM documentation within their existing business processes.

Knowledge consists of experiences, values and related information. The Knowledge owner follows a framework to analyze and adopt new experiences and information. Information is converted to knowledge when it is put into action. Knowledge can be both explicit and tacit. (Non-aka and Takeuchi 1995; Davenport and Prusak 1998).

Knowledge Management involves gathering, organizing, analyzing and sharing knowledge to create an environment in which employees are able to gear up their individual knowledge, and make use of this knowledge more effectively and productively. (Alavia and Lediner 1999; Brelade and Harman 2001).

A Knowledge Management systems life cycle (KMSLC) is a model that describes the phases of deploying Knowledge Management and the respective sub-processes on each phase. (Awad ve Ghaziri, 2004: 24; Mustafa Sagsan, 2006).

After several years of developing a KM program in a Personal Care Products manufacturing company, the authors of this paper have developed an effective KM initiative methodology termed “SKMIM”, which is a set of standard guideline and consultation tools for KM deployment. “SKMIM” is tailor designed for managing

### “Knowledge on Business Processes”.

In addition, most organizations have well defined and documented their business processes by adopting the traditional process documentation regime. However, in most cases current processed documents contain only basic business process information such as information about operational flow, working guidelines and scope of owners' responsibilities. It is not uncommon that many relevant information such as government regulations, tacit Knowledge and external product and/or services standards are not fully incorporated or are not even incorporated in the traditional process documentation regime.

According to Awad and Ghaziri (2004:24), there are four processes in knowledge management, namely “Capturing”, “Organizing”, “Refining” and “Transferring”. The Capturing Phase is about knowledge capturing and includes the collection of discussion threads, audio files and digital files. During the “Organizing Phase”, the captured data or information would be organized in such manner that it could be retrieved and used to generate useful knowledge. Indexing, Clustering, Cataloguing and other organizational methods would be used in this phrase. The third and fourth phrases of knowledge management are “Refining” and “Transferring”. Knowledge would be filtered and disseminated or transferred within the organization by proper channels such as the provision of training to staff.”

To help closing the gap between traditional process documentation and KM methodology, more detailed study and investigation are needed. The authors have elected to conduct the two proof of concept projects by studying two departments, namely, the Engineering Department and the Purchasing Department of a large “Personal Care Products” manufacturing company.

This Personal Care Products manufacturing company is a subsidiary under the Personal Care Division of a large multinational company with its headquarters located in North America. It is a medium sized company with 1500-2000 factory workers and 250 office staff in Guangzhou, China. It manufactures and exports a large volume of Personal Care Products to overseas countries. Each year, Over 90% of the products are sold overseas. This Company possesses ISO certification; therefore all process documents are periodically revised by the key departmental staff and approved by the respective Department Heads.

At the initial stage of the Project, the work role of a newly employed “Sourcing Clerk” was studied by the Authors. This “Sourcing Clerk” reports to a “Sourcing Manager” and his duties include “sourcing material or components” from different vendors both in China and other Asia Countries. The Sourcing Clerk is responsible for first chart level Vendor Management and the initial screening of sourced items from vendors.

Having limited knowledge of a Sourcing function, the Authors have to undergo a rigorous learning phrase which includes studying the process documents on file and interviewing with other collaborating members of staff. By following the explicit and implied instructions on the functional documents, the Authors were able to complete the purchasing forms, and process the purchasing documents for approval correctly. On the other hand, without going through similar learning process, the new Sourcing Clerk was not able to perform the role and responsibilities of a “Sourcing Clerk” right away. In this particular case, the subject clerk was still not able to perform the required task due to the lack of certain knowledge relating to “Customs laws” and regulations imposed by the Government Authorities. In another situation, the same Sourcing Clerk was not able to perform due to the lack of certain basic “Engineering and Product Knowledge.”

One may find it interesting to know that most of the knowledge required for the sourcing job are readily available in the public domain. However, for some reasons, the “Sourcing Clerk” is either unaware of its existence or ignorant of its importance to the success of the operation.

The Authors then performed the same exercise on the Engineering Department. This time, the Authors assumed the role of a newly recruited “Engineer”. This engineer's duties include “meeting the machine up-time KPI”, “meeting the QA requirements”, “manufacturing Machines maintenance and fine tuning”, “factory facility management” etc. The Engineer reports to the Departmental Head Engineer. Same as other new employees of the firm, this engineer studied the various departmental work instructions to build up his working knowledge. These work instruction documents contains detailed information required for this engineer to perform his normal duties. In analyzing the performance of this new engineer for a particular machine maintenance task, it was found that the history of the machine setting was included in the work instruction documents. The rationale behind the current machine setting remains a mystery. without this information, the engineer has to repeat the “Trial-and-Error” process to find out the right settings.

The Authors learnt from their experience in the Company that “Tacit Knowledge” and certain components of “Explicit Knowledge” are not included in the traditional process documentation. From the above experience, only “Key Explicit Knowledge” is found in these process documents, but “Tacit and certain components of Explicit Knowledge” that are tied with the individual process are often ignored or excluded from the documentation. In view of the flaws in the traditional process documentation, a systematic way to manage the missing knowledge components is needed. SKMIM is designed with a view that merging Tacit and Explicit Knowledge with Business Processes will significantly improve business operations.

### SUMMARY

Embodiments of the present invention relate to systems and methods for associating business processes with knowledge management. Certain embodiments of the invention include a processor and a memory. The memory stores instructions that cause the processor to perform a method comprising performing, by executives of an enterprise, a knowledge assessment to collect documents of the entire enterprise. Consistent with the embodiments, the method further comprises associating all of the required documents related to a business process of the enterprise; editing the collected documents by an assigned owner of the documents, a new employee of the enterprise; and performing a knowledge management audit by the executives of the enterprise.

Consistent with certain embodiments of the invention, the memory storing instructions that cause the processor to perform a method may comprises other steps, including performing, by executives of an enterprise, a knowledge assessment to collect documents of the entire enterprise, wherein a priority value is assessed with respect to each of the collected documents; associating all of the required documents related to a business process of the enterprise, wherein each of the collected documents is classified and associated with a step related to a task required to be performed in the business process; wherein each document associate further with a set of elements, and wherein the document owner is enabled to locate documents visually on the flowchart, in view of the set of elements; editing the collected documents by an assigned owner of the documents, a new employee of the enterprise, wherein the new employee is assigned a case by the employee's supervisor; wherein the new employee starts working on the case, by referring to a particular step of a particular task of a business process; and wherein the new employee finish working on the case.

In accordance with an embodiment of the present invention, wherein each of the collected documents is classified and associated with a step related to a task required to be performed in the business process, for each of the business process, using existing office automation tools to create a flow chart with information indicating each of the classified documents associated with the step related to the task required to be performed in the business process, displaying the flow chart to users; and by using the flow chart, allowing users to quickly locate all required documents related to the step and the task of the business process.

In an alternative embodiment, the inventive system, wherein each document associate further with a set of elements, the set of elements including: a GPS Location Requirement, where the Requirement requires a location where a given document can be made accessible; a document owner who can access a given document with respect to the GPS Location Requirement; and a Document Allowed Time where the document owner is allowed to access the given document with respect to the GPS Location Requirement.

In yet another embodiment, the set of elements further includes a Document Allowed Mode where the document owner is allowed to access the given document with respect not only the GPS Location Requirement but also mode of accessing the document, including mobile devices, home computers, and work computers; and a Document Frequency, wherein the given document is limited to access by minutes or hours on a given day, with respect to the GPS Location Requirement; and wherein the document owner is enabled to locate documents visually on the flowchart, in view of the set of elements, the set of elements further includes the GPS Location Requirement, the document owner, the Document Allowed Time, the Document Allowed Mode, the Document Allowed Mode, and the Document Frequency.

In an additional embodiment, the owner's requirements further comprises: assessing if the new employee fails to comply the GPS Location Requirement by accessing the collected documents in other unpermitted locations; assessing the collected documents by other unauthorized employees; assessing the collected documents outside the Document Allowed Time; assessing the collected documents using modes other than the Document Allowed Mode; assessing the collected documents at a frequency beyond the allowed Document Frequency; assessing if document retention policies are followed by the new employee; assessing if document refreshment policies are followed by the new employee; and assessing if the new employee has sufficient qualification related to performing the associated task.

In another embodiment, wherein the new employee starts working on the case, the method further comprises establishing connection with the system by the new employee, working under special circumstances, by the new employee, and provided additional features to ensure the new employee to be working under a highly restrictive environment.

In accordance with an embodiment of the present invention, wherein the establishing connection with the system further comprises the new employee inserts a USB device to a computing device and the USB device is configured to include a GPS receiver, the system requires receiving authentication based on Input from the new employee and a current GPS location reported by the GPS receiver included in the USB device; and the system authenticates the new employee based on the GPS Location Requirement, the new employee, the Document Allowed Time, the Document Allowed Mode, and the Document Frequency.

Furthermore, in one embodiment, the special circumstances may further comprises that whenever GPS signals are blocked and the current GPS location reported by the GPS receiver included in the USB device is not available, remembering last GPS location before the GPS signals are blocked, allowing continued access to the collected documents, and starting a GPS High Alert Mode to monitor activities of the new employee.

Alternatively, in a different embodiment, the special circumstances may further comprises that whenever GPS signals are being blocked, stopping complete access by the new employee to the collected documents, until the GPS signals resume, as a prevention of possible access violation to the collected documents by the new employee with respect to complying the GPS Location Requirement.

As another alternative, the special circumstances may further comprises that when GPS signals are blocked and the current GPS location reported by the GPS receiver included in the USB device is not available, remembering last GPS location before the GPS signals are blocked, allowing access to some collected documents that assigned lower importance, and starting a GPS High Alert Mode to monitor activities of the new employee.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating an architecture of an exemplary system, consistent with an embodiment of the present invention.

FIG. 2 is a flow diagram illustrating an exemplary Knowledge Assessment Form, consistent with an embodiment of the present invention.

FIG. 3 is a flow diagram illustrating an exemplary Knowledge Audit Checklist form, consistent with an embodiment of the present invention.

### DETAILED DESCRIPTION

Embodiments of the present invention relate to systems and methods for associating business processes with knowledge management. Certain embodiments of the invention include a processor and a memory. The memory store instructions that cause the processor to perform a method. According to one embodiment, the method comprises performing, by executives of an enterprise, a knowledge assessment to collect documents of the entire enterprise. The method further associates all of the required documents related to a business process of the enterprise. Additionally, the method edits the collected documents by an assigned owner of the documents, a new employee of the enterprise. Then, the method performs a knowledge management audit by the executives of the enterprise.

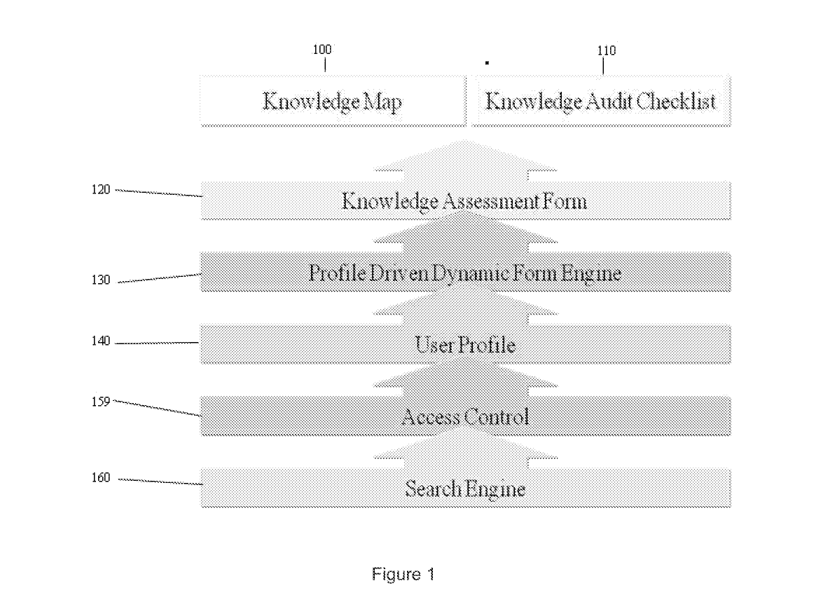

Referring to FIG. 1, an exemplary system of the present invention is illustrated. In an enterprise, executives may use a knowledge map 100 a knowledge audit checklist 110 to conduct a knowledge assessment 120 to collect documents of the entire enterprise. The assessment includes using profile driven dynamic form engine 130 and user profile 140 to associate all of the required documents related to a business process of the enterprise. Afterwards, a staff, such as a new employee of the enterprise, which can also be defined as an assigned owner of the documents, is allowed to edit the collected documents by an assigned owner of the documents through an access control 150 mechanism. Periodically, executives of the enterprise may perform a knowledge management audit to monitor the productivity of staff or the new employee. Alternatively, the executives may take advantage of the search engine 160 to monitor the activities of individual employees.

In accordance with an embodiment of the present invention, in performing the knowledge assessment, a priority value is assessed with respect to each of the collected documents. More, to associate the required documents, each of the collected documents may be classified and associated with a step related to a task required to be performed in the business process. In the process, each document may further associate with a set of elements, such that the document owner is enabled to locate documents visually on the flowchart, in view of the set of elements. When the collected documents are edited, the staff of the new employee is assigned a case by the employee's supervisor. The staff or the new employee may start working on the case, by referring to a particular step of a particular task of a business process, before allowing the staff or the new employee finish working on the case.

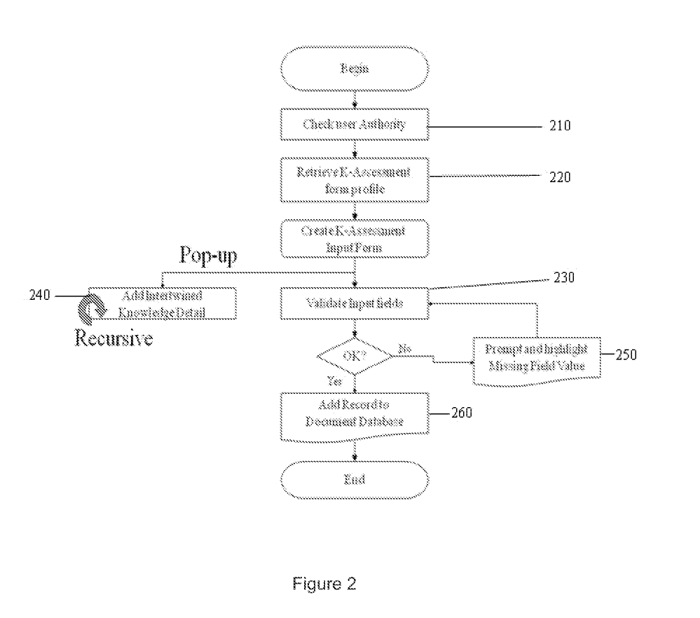

Now, referring to FIG. 2, consistent with embodiments of the invention, whereas each of the collected documents is classified and associated with a step related to a task required to be performed in the business process and for each of the business process, the inventive system may use existing office automation tools to create a flow chart with information indicating each of the classified documents associated with the step related to the task required to be performed in the business process. The flow chart may then be displayed to users to allow all other users to quickly locate all required documents related to the step and the task of the business process. Here, after checking user authority 210, k-assessment form profile may be retrieved (step 220). For validation, input fields should be examined (step 230), and any missing information should be highlighted (step 250). In case of any inter-wined knowledge being found, the knowledge should be added. (step 240) When checking is completed, records should be added back to the document database (step 260).

Referring back to FIG. 1, in performing the knowledge assessment, documents are collected to conduct knowledge assessments 120. These documents may further be associated with a set of elements. In an additional embodiment, the set of elements may include a number of items that help identify the uniqueness of certain documents. One element may be associated with a GPS Location Requirement, where the Requirement requires a location where a given document can be made accessible. Another element may be related to a document owner who can access a given document with respect to the GPS Location Requirement. Alternatively, an element may be related to a Document Allowed Time where the document owner is allowed to access the given document with respect to the GPS Location Requirement.

In an alternative embodiment, the documents collected may include an element associated with a Document Allowed Mode where the document owner is allowed to access the given document with respect not only the GPS Location Requirement but also mode of accessing the document, including mobile devices, home computers, and work computers. The element may also be related to a Document Frequency, where it is defined as a given document that is limited to access by minutes or hours on a given day, with respect to the GPS Location Requirement. When the document owner is enabled to locate documents visually on the flowchart, in view of the set of elements, the set of elements may further include the GPS Location Requirement, the document owner, the Document Allowed Time, the Document Allowed Mode, the Document Allowed Mode, and the Document Frequency.

Once the documents are collected and the appropriate associations are made, the new employee may start working on the case. According to one embodiment, the staff or new employee may establish connections with the system with additional security features. The new employee may insert a USB device to a computing device and the USB device is configured to include a GPS receiver. The system would require receiving authentication based on Input from the new employee and a current GPS location reported by the GPS receiver included in the USB device. The authentication means may be based on a number of choices, including but not limiting to: the GPS Location Requirement, the new employee, the Document Allowed Time, the Document Allowed Mode, and the Document Frequency.

In some cases, the staff or the new employee may be allowed to work under special circumstances, ensuring the new employee to be working under a highly restrictive environment. On such circumstance may be related to GPS signals availability. When GPS signals are blocked and the current GPS location reported by the GPS receiver included in the USB device is not available, the last GPS location before the GPS signals being blocked may be remembered, thus allowing continued access to the collected documents to start a GPS High Alert Mode to monitor activities of the new employee.

Alternatively, the staff or the new employee may be allowed to work under a different circumstance. In such a case, when GPS signals are being blocked, complete access by the new employee may be stopped to collect documents, until the GPS signals resume, as a prevention of possible access violation to the collected documents by the new employee with respect to complying the GPS Location Requirement.

Furthermore, other restrictions may apply to other classes of employees. As another example, when GPS signals are blocked and the current GPS location reported by the GPS receiver included in the USB device is not available, the last GPS location before the GPS signals are blocked, only some documents are allowed accessed. To further enforce security, a GPS High Alert Mode may be started to monitor activities of the suspicious employees.

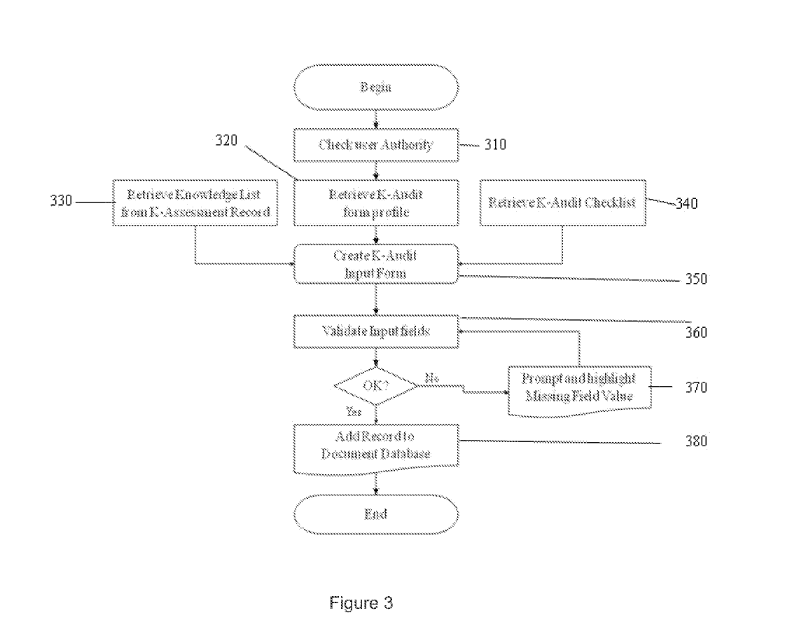

Periodically, as mentioned, executives of the enterprise may perform a knowledge management audit to monitor the productivity of staff or the new employee. Referring to FIG. 3, the executives determine whether an owner has fulfilled the owner's requirements. Such determinations include assessing if the new employee fails to comply the GPS Location Requirement by accessing the collected documents in other unpermitted locations. Additionally, the determinations include: assessing the collected documents by other unauthorized employees; assessing the collected documents outside the Document Allowed Time; assessing the collected documents using modes other than the Document Allowed Mode; assessing the collected documents at a frequency beyond the allowed Document Frequency; assessing if document retention policies are followed by the new employee; assessing if document refreshment policies are followed by the new employee; and assessing if the new employee has sufficient qualification related to performing the associated task. At this time, after checking user authority 310, k-audit form profile may be retrieved (step 320). Additionally, knowledge list may be retrieved from k-assessment records (step 330). Moreover, k-audit checklist may be retrieved (step 340) to create k-audit input forms (step 350). For validation, input fields should be examined (step 360), and missing details should be highlighted and prompted back to the users (step 370). When checking is completed, records should be added back to the document database (step 380).

The present techniques and embodiments described herein, including the exemplary systems and methods presented above, can be implemented in digital electronic circuitry, or in computer hardware, firmware, software, or in any suitable combinations thereof. In addition, apparatus and systems consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A system for associating business processes with knowledge management, comprising:
a processor; and
a memory storing instructions that cause the processor to perform a method, the method comprising:
performing, by executives of an enterprise, a knowledge assessment to collect documents of the entire enterprise;
associating all of the required documents related to a business process of the enterprise;
editing the collected documents by an assigned owner of the documents, a new employee of the enterprise; and
performing a knowledge management audit by the executives of the enterprise.

2. The system of claim 1, wherein:
the performing of the knowledge assessment, a priority value is assessed with respect to each of the collected documents;
the associating all of the required documents,
each of the collected documents is classified and associated with a step related to a task required to be performed in the business process;
each document associate further with a set of elements; and
the document owner is enabled to locate documents visually on the flowchart, in view of the set of elements; and
the editing of the collected documents,
the new employee is assigned a case by the employee's supervisor;
the new employee starts working on the case, by referring to a particular step of a particular task of a business process; and
the new employee finish working on the case; and
the performing the knowledge management audit by the executives of the enterprise, wherein the knowledge management audit determines whether an owner has fulfilled the owner's requirements.

3. The system of claim 1, wherein:
when each of the collected documents is classified and associated with a step related to a task required to be performed in the business process,
for each of the business process, using existing office automation tools to create a flow chart with information indicating each of the classified documents associated with the step related to the task required to be performed in the business process,
displaying the flow chart to users; and
by using the flow chart, allowing users to quickly locate all required documents related to the step and the task of the business process.

4. The system of claim 1, wherein the set of elements further includes:
a GPS Location Requirement, where the Requirement requires a location where a given document can be made accessible;
a document owner who can access a given document with respect to the GPS Location Requirement; and
a Document Allowed Time where the document owner is allowed to access the given document with respect to the GPS Location Requirement.

5. The system of claim 4, wherein the set of elements further includes:
a Document Allowed Mode where the document owner is allowed to access the given document with respect not only the GPS Location Requirement but also mode of accessing the document, including mobile devices, home computers, and work computers; and
a Document Frequency, wherein the given document is limited to access by minutes or hours on a given day, with respect to the GPS Location Requirement; and
wherein the document owner is enabled to locate documents visually on the flowchart, in view of the set of elements, the set of elements further includes the GPS Location Requirement, the document owner, the Document Allowed Time, the Document Allowed Mode, the Document Allowed Mode, and the Document Frequency.

6. The system of claim 5, wherein the new employee starts working on the case, the method further comprises:
establishing connection with the system by the new employee,
working under special circumstances, by the new employee, and
provided additional features to ensure the new employee to be working under a highly restrictive environment.

7. The system of claim 6, wherein the establishing connection with the system further comprises:
the new employee inserts a USB device to a computing device and the USB device is configured to include a GPS receiver,
the system requires receiving authentication based on Input from
the new employee and a current GPS location reported by
the GPS receiver included in the USB device; and
the system authenticates the new employee based on:
the GPS Location Requirement,
the new employee,
the Document Allowed Time,
the Document Allowed Mode, and
the Document Frequency.

8. The system of claim 7, wherein the special circumstances further comprises:
when GPS signals are blocked and the current GPS location reported by the GPS receiver included in the USB device is not available,
remembering last GPS location before the GPS signals are blocked,
allowing continued access to the collected documents, and
starting a GPS High Alert Mode to monitor activities of the new employee.

9. The system of claim 7, wherein the special circumstances further comprises:
when GPS signals are being blocked, stopping complete access by the new employee to the collected documents, until the GPS signals resume, as a prevention of possible access violation to the collected documents by the new employee with respect to complying the GPS Location Requirement.

10. The system of claim 7, wherein the special circumstances further comprises:
when GPS signals are blocked and the current GPS location reported by the GPS receiver included in the USB device is not available,
remembering last GPS location before the GPS signals are blocked,
allowing access to some collected documents that assigned lower importance, and
starting a GPS High Alert Mode to monitor activities of the new employee.

11. The system of claim 10, wherein the owner's requirements further comprises:
assessing if the new employee fails to comply the GPS Location Requirement by accessing the collected documents in other unpermitted locations;
assessing the collected documents by other unauthorized employees;
assessing the collected documents outside the Document Allowed Time;
assessing the collected documents using modes other than the Document Allowed Mode;
assessing the collected documents at a frequency beyond the allowed Document Frequency;
assessing if document retention policies are followed by the new employee;
assessing if document refreshment policies are followed by the new employee; and
assessing if the new employee has sufficient qualification related to performing the associated task.
